(19) United States
(12) Patent Application Publication
(10) Pub. No.: US 2007/0005381 A1
(43) Pub. Date: Jan. 4, 2007

(54) Automated system and method for ordering goods and services

(76) Inventor: Mikhail Prokushev, Toronto (CA)

Correspondence Address: MIKHAIL PROKUSHEV, 77 WARWOOD ROAD, TORONTO, ON, M9B 5B6, CA

(21) Appl. No.: 11/171,527

(22) Filed: Jul. 1, 2005

(51) Int. Cl. G06Q 99/00

(52) U.S. Cl. 705/1

(57) ABSTRACT

A system and method for facilitating the ordering of goods and services by a user consisting of a system database for storing data received from a user and one or more service providers. The data is associated with one or more orders for goods and services submitted by said user and goods and services provided by one or more qualified service providers. Interfaces are provided for receiving and communicating the one or more orders from the user to the one or more qualified service providers. The system and method includes at least one module connected to the system database and the one or more interfaces to analyze the orders and to identify and rank at least one qualified service provider for fulfilling the one or more orders for the user.

### FIELD OF THE INVENTION

This invention relates to a system and method for ordering services through a communication means, and more particularly to a computerized system and method for receiving orders for goods and/or services from a user and identifying and ranking qualified service providers capable of fulfilling the orders by providing the goods and/or services.

### BACKGROUND OF THE INVENTION

Personal assistants or butlers are frequently utilized by busy individuals to manage their day-to-day domestic tasks and the ordering of goods and services. The reliance on the services of a butler enables the individual to balance the demands of their family, career and hobbies. Traditionally, the fast paced lifestyles of senior business executives, politicians and royalty have necessitated the services of butlers.

In most modern families, the financial and personal demands associated with managing a household require that both parents maintain full-time employment. During the course of their employment, these individuals are unable to attend to any day-to-day household related tasks, such as, for example, hiring repair personnel and purchasing groceries. Following the workday, these individuals must hurriedly attend to the household tasks thereby limiting the amount of time they can share with their spouse, children and friends. Although the services of a butler would provide immeasurable benefits to the wellness of modern families, the considerable costs associated with hiring a butler has limited their availability to only the most affluent members of our society.

Various electronic devices and automated systems have been developed to help individuals manage their time and commitments for efficiently. Electronic devices, such as personal digital assistants (PDAs), are commonly utilized by individuals to provide reminders, schedule meetings and store contact information. To a limited extent, these devices have improved the ability of an individual to manage their day-to-day tasks. However, since these devices are not adapted to perform the day-to-day tasks, such as scheduling appointments with repair personnel, the actual time saved through the use of such electronic devices is minimal.

Many financial institutions and business in the service sector have developed automated systems to efficiently receive and respond to orders and inquiries placed by their customers. When utilizing existing automated ordering systems, the customer must patiently listen to recorded messages and/or information outlining the various services that the business offers. In order to actually submit an order, the user must navigate through countless levels and options before finally locating the goods or services they desire. In many instances, when the user has located the desired good or service, their call is then directed to the next available agent. Also, after navigating through each level and option, the user may not have found a good or service that satisfactorily fulfills their requirements. In both instances, the user must devote a considerable amount of time and energy to locating an agent capable of receiving and fulfilling their order.

Accordingly, there remains a need for a system and method for ordering goods and services whereby the customer inputs an order and the system automatically identifies and arranges for a good or service provider to complete the order. In particular, there is a need for a system and method that functions much like an automated butler whereby the user simply inputs orders and the system automatically locates a qualified service provider to fulfill the order.

### SUMMARY OF THE INVENTION

The present invention relates to a system and method for facilitating the ordering of goods and services by a user. In preferred embodiments of the invention, the invention relates to a computer-based system and method of receiving orders from a user and identifying and ranking one or more qualified service providers to fulfill the orders. According to one aspect of the present invention, the present invention comprises a system database for storing data received from a user and one or more service providers, where the data is associated with one or more orders for goods and services submitted by said user, and where the data is further associated with goods and services provided by one or more qualified service providers. The system includes one or more interfaces for receiving the one or more orders from the user and for communicating the one or more orders to the one or more qualified service providers. At least one module is connected to the database and the one or more interfaces, where the module is programmed to analyze said one or more orders to identify and rank at least one qualified service provider for fulfilling the one or more orders for said user.

According to an aspect of the present invention, the present invention is directed to a method for facilitating the ordering of goods and services by a user comprising the steps of receiving one or more orders for goods and services from said user, where said one or more orders identify the goods and services requested, analyzing and transcribing the one or more orders to determine the goods and services requested by the user, generating a list of one or more qualified service providers to provide the goods and services requested to said user, ranking and selecting at least one available qualified service provider from the list of one or more qualified service providers, and communicating with the at least one available qualified service provider to fulfill said one or more orders for goods and services for said user.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a schematic diagram illustrating an automated ordering system for ordering goods and services in an embodiment of the present invention;

FIG. 2 is a schematic diagram illustrating an automated ordering system for ordering goods and services via the Internet in an alternate embodiment of the present invention;

FIG. 3A is a flowchart illustrating steps in a method of ordering one or more goods or services in an embodiment of the present invention;

FIG. 3B is a flowchart illustrating steps in a method of ordering one or more goods or services in an embodiment of the present invention;

FIG. 4 is a hierarchical schematic for the ranking of qualified service providers based on the geographic location of the user; and

FIG. 5 is a hierarchical schematic for the ranking of qualified service providers based on the goods and/or services ordered by the user.

### DETAILED DESCRIPTION OF THE INVENTION

The present invention relates to a system and method for facilitating the automated ordering of goods and services via a communication network. In the specification and in the claims, the word “user” refers to the individual or business seeking to order one or more goods and/or services using the system and method of the present invention. Similarly, the word “service provider” refers to the individual or business qualified to fulfill the user's one or more orders by supplying the requested goods and/or services.

In preferred embodiments of the invention, the invention relates to a computerized system and method for ordering goods and services whereby the user communicates with an automated system to order one or more goods or services. Following the submission of the order, the user may disengage from the automated system. Upon receipt of the order, the system automatically locates and arranges for a qualified service provider to fulfill the order. The automated system is designed to contact successive qualified service providers until an available qualified service provider is located. The automated system is adapted to determine the contact data of the user based on a pre-set identifier. The pre-set identifier may be the user's telephone number or any other suitable means of identifying the user. The contact data may include the name of the user, location of the user's business or residence, billing information and user's ordering history, for example. Using the user's contact data, the qualified service provider may attend at the user's residence or business to deliver the ordered goods or perform the requested service.

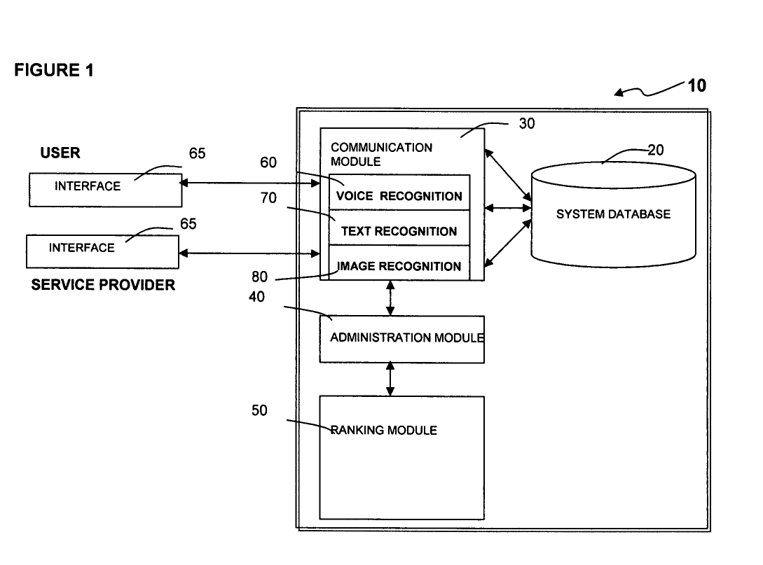

Referring to FIG. 1, a schematic diagram of an automated ordering system for requesting goods and services in an embodiment of the present invention is shown generally as 10. Ordering system 10 comprises a system database 20 for storing the orders and data relating to the users and the service providers, a communication module 30 adapted to communicate with the users to receive orders and to communicate with the service providers to send the orders, an administration module 40 programmed to maintain and update data stored in system database 20, and a ranking module 50 programmed to identify and select one or more qualified service providers to fulfill the orders received from the user. In this embodiment of the present invention, system database 20, communication module 30, administration module 40 and ranking module 50 reside on a single application server or processor, although in variant embodiments of the present invention, one or more of these components may reside on different servers or processors.

System database 20 is adapted to receive and store the user's order and, if necessary, for first time users, the user's contact data from the communication module 30. System database 20 is also adapted to communicate data relating to one or more qualified service providers to the ranking module 40, and to receive and store the qualified service provider rankings from the ranking module 40. Generally, the data relating to the one or more qualified service providers may be stored in one or more hierarchies in system database 20. The database hierarchies may be used to organize the user data and the service provider data in a physical or logical structure. Most service providers may already be physically or logically organized in a hierarchical structure for good and service ordering purposes, which may make the task of selecting and ranking qualified service providers in implementing the present invention less complicated. Such hierarchies may be defined by the categories of the goods and services that the service providers offer, cost and/or their geographic location. Sub-hierarchies may be further defined within each category of goods and services based on user feedback and reviews received by the ordering system 10 in respect to each specific qualified service provider. Service providers having positive feedback or reviews may be ranked higher in the hierarchy than those having poorer feedback.

Orders and data received from users may also be structured in a hierarchical manner, and can be easily compared and correlated with the service provider hierarchies and/or sub-hierarchies. Database 20 may be any known relational database, as manufactured by Oracle and Sybase, for example. However, it is understood that any suitable database may be utilized with the present invention.

Communication module 30 may be programmed to determine whether the user's order is “voice only”, “text only”, “image only” or any combination of voice, text and/or image. If the incoming order is in voice-only format, a voice recognition module 60 of communication module 30 will receive and analyze the order. Voice recognition module 60 may utilize any known voice recognition technology, as manufactured by ScanSoft, Nuance, Dragon or Advanced Recognition Technologies Inc., for example. However, it is understood that any suitable voice recognition technology may be utilized with the present invention.

If the incoming order is in text-only format, the communication module 30 will initiate the text recognition module 70 to receive and analyze the order. If the incoming order consists of both voice and text data, the voice recognition module and text recognition modules 60 and 70 will receive and analyze the respective voice and text components of the order separately. Preferably, the voice and text recognition modules 60 and 70 are adapted to receive and translate the orders to and from any language. This will enable the system 10 to receive orders and to arrange for the fulfillment of the orders from users situated anywhere in the world.

Alternatively, if the incoming order is in image-only format, the communication module 30 will initiate the image recognition module 80 to receive and analyze the order. Image recognition module 80 may utilize any known image recognition, optical character recognition or pattern recognition technology to analyze the image-based order from the user. Any suitable image recognition technology capable of efficiently and accurately analyzing the image orders may be utilized with the present invention, such as, for example, technology manufactured by Attrasoft and EnerSoft. If the incoming order consists of image and text data, image and voice data, or image, text and voice data, the communication module 30 will initiate the necessary recognition modules so as to analyze the order.

System 10 also comprises one or more interfaces 65 through which data may be received as input from the user and provided as output to the one or more service providers. The input interfaces 60 may be any communication device adapted to send and receive orders to and from the communication module 30. The interfaces 65 and communication module 30 may communicate via any suitable communication network, such as, for example, a satellite, antennae, wired, wireless or cable-based network. Orders are preferably transmitted to and received by the communication module 30 as voice data, such as, for example, direct voice, voice mail, voice XML, voice over internet protocol (VoIP) and MP3s. Once the qualified service providers have been ranked, the order messages are then preferably sent to one or more of the service providers as text-based messages for quick transmission. It is understood that the order messages may be sent to and from the service providers and users, respectively, using any suitable format, such as, for example, HTML-based documents, pages and electronic mail messages. Interfaces 65 can include telephones, fax machines, computers, personal digital assistances (PDAs), cellular telephones, pagers, portable electronic messaging or other messaging devices, handheld organizers, portable computing devices or other devices.

As an example, a user may communicate with the ordering system 10 to request or “order” the services of a plumber to repair a leak in his home. The user would use a telephone interface 50 to communicate with the communication module 30 of the ordering system 10 and provide their pre-set identifier. When prompted by the communication module 30, the user would then state the nature and quantity of the goods and/or services they require. To request the services of a plumber, for instance, the user may state “I need a plumber” or simply “plumber”. The user may now disengage from the ordering system 10 or proceed to submit another order. The voice recognition module 60 of the communication module 30 would then analyze and transcribe the verbal order received from the user into a computer and/or human readable format.

The administration module 40 would then correlate the order with the user's contact data using the pre-set identifier and store the order in the database 20. The ranking module 50 accesses the database 20 and selects one or more qualified service providers capable of providing the plumbing services to the user. The ranking module 50 may select one or more qualified service providers based on a variety of criteria, such as, for example, their proximity to the user's residence or business and the quality and affordability of their goods or services. The communication module 30 then sends the user's order and contact information to the one or more plumbers who are registered as qualified service providers with the ordering system 10.

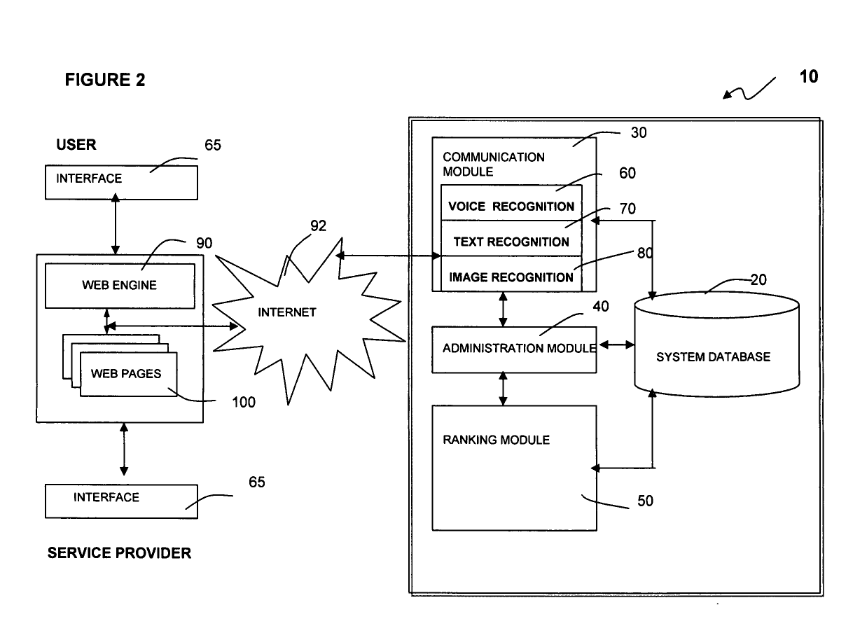

In an alternate embodiment of the present invention, interface 65 is web-based, allowing users to order goods or services through communication module 30 of ordering system 10 via the Internet. Referring to FIG. 2, an embodiment of the present invention where the interface 65 is web-based is shown. Interface 65 comprises a web engine 90 connected to communication module 30 and the ranking module 50. Web engine 80 generates the content of one or more web pages 100 for ordering goods or services using data obtained from communication module 30 and database 20. The web pages 90 may include a log in screen and an ordering screen for sending a request from goods and/or services. The web pages 90 are accessible over the Internet 92 by a user through the user's interface 65, such as a personal computer, cellular telephone or PDA. To order a good or service, the user would input a text message or keywords that describe the goods or services they desire. Alternatively, the user may record a voice message which will then be attached to the order in VoIP format. Furthermore, the user may also attached an image file which illustrates the good and/or service he or she would like to order. The image file may be in any suitable file format such as, for example, JPEG, TIF, PNG, GIF, and BMP. The text recognition module 70 and administration module 40 would then analyze the text-message or keywords to correlate the order with the user's contact data and store the order in the database 20. The ranking module 50 would access the database 20 and select one or more qualified service providers capable of providing the goods and/or services to the user.

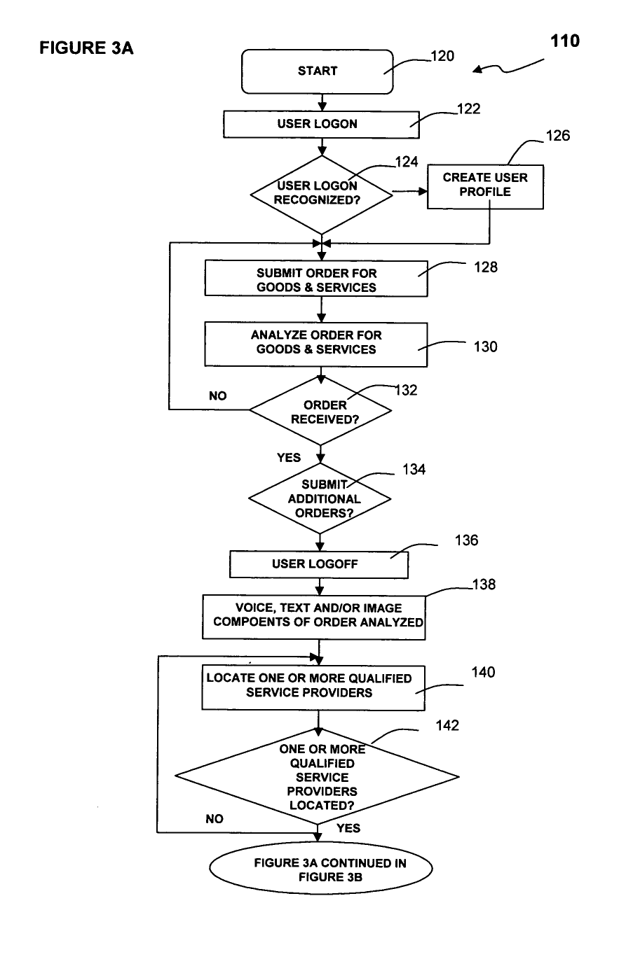

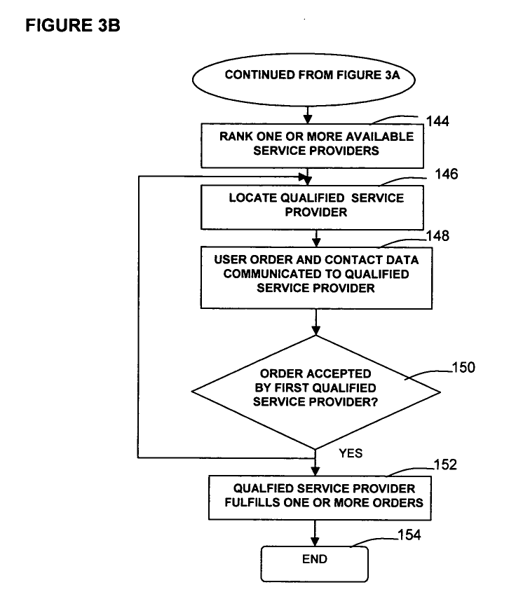

In a preferred embodiment of the invention, ordering system 10 is used to facilitate the ordering and provision of goods and services between a user and one or more qualified service providers. The present invention allows for the efficient ordering of goods and services by a user whereby the user communicates their one or more orders and the ordering system 10 automatically ranks and then selects one or more available service providers to fulfill the order by providing the requested goods and/or services. By this design, the ordering system 10 will limit, if not eliminate, the need for the user to conduct timely independent searches of telephone directories and the Internet, for example, for qualified service providers. An embodiment of a method of facilitating the ordering of goods and services, and the efficient ranking and selection of a qualified service provider is described below with reference to FIGS. 3 to 5.

Referring to FIGS. 3A and 3B, steps in an embodiment of a method of facilitating the efficient ordering and provision of goods and services between a user and one or more qualified service providers are shown generally as 110, and commences at step 120. At step 122, a user logs on to the ordering system (e.g. ordering system 10 of FIG. 1) by identifying himself or herself using a pre-set identifier. The user's telephone number may be used as a pre-set identifier to confirm the identity of the user. The user may also be instructed by the ordering system 10 to provide a numerical password to verify their identity.

Other means of providing users with access to the ordering system may be implemented as known in the art. When a user connects to the ordering system 10 using a computer or PDA interface, for example, the login procedure may include a username and password. The login procedure may be implemented at various steps throughout the method, such as, for example, before or after the user has submitted their order.

At 124, if the user's pre-set identifier is not confirmed or recognized by the communication module 30, the method proceeds to step 126 and the user is instructed to create a user profile. A user's pre-set identifier may not be confirmed or recognized if the user's telephone number is unlisted or blocked. Following the creation of a profile, the ordering system 10 may verify the user's identity by calling the pre-set identifier and receiving the user's confirmation.

At step 128, the user is prompted to communicate an order. The manner by which the user submits their order will depend on the type of interface 65 being used. If the user is communicating with the ordering system using a telephone, at step 130 the ordering system may simply “beep” to indicate that the system is prepared to record the user's order. Additionally, at step 128, the system may be adapted to ask a series of questions to prompt the user to submit an order, such as, for example, “Would you like to order a service?”, “Please state the service you require”, or “When do you require the good or service?”. Alternatively, if the user is communicating with the ordering system 10 using a computer, PDA or similar device, at step 130 the ordering system may have a text field for inputting the order. Also, the user may attach voice and/or image files so as to further particularize his or her order.

At step 130, the ordering system analyzes the order in real time, including the nature of the goods and/or services requested, the quality of the order (e.g. sound and image quality of the order). If the quality of the order is poor, the system may prompt to user to re-submit their order at step 132. Also, at step 132, the system may adjust the settings of the communication module 30 to account for the poor quality of the order (e.g. increase the volume, for example) and to ensure the receipt of an order having an adequate signal and/or image quality. It will be obvious to those skilled in the art that many other functions may be implemented in the ordering system without departing from the spirit of the invention. For example, the ordering system can be adapted to request additional information from the user concerning their order, such as their price limitations and payment preferences.

If at step 134, the user has successfully communicated their order and requests to disconnect from the ordering system, the user may hang-up the telephone or log off the ordering system at step 136. Alternatively, the user may request at step 134 to submit additional orders. The flow of the method will then proceed back to step 128, at which time the ordering system will await a second order from the user. Once the user has submitted one or more orders and has disconnected at step 136, the method proceeds to step 138.

At step 138, the ordering system analyzes the voice, text and/or image components of the order so as to transcribe the order into a computer and/or human readable format. The particulars of the goods and/or services requested by the user are extracted from the voice, text and/or image order and correlated with the user's contact data. The correlated order and contact data may then be stored by the ordering system in the system database.

At step 140, the ordering system utilizes the user's contact data and the particulars of the goods and/or services to locate and rank one or more qualified service providers. If the user has ordered the identical good or service previously, the ordering system may be programmed to rank the most recently used qualified service provider higher than other qualified service providers. At step 140, if the user has not ordered the goods and/or services previously, the ordering system will determine the geographic location of the user's residence or business based on the contact data and/or the pre-set identifier. If the user's contact information consists of only their pre-set identifier, the system 10 may be adapted to perform a reverse telephone directory search for the residential or business address.

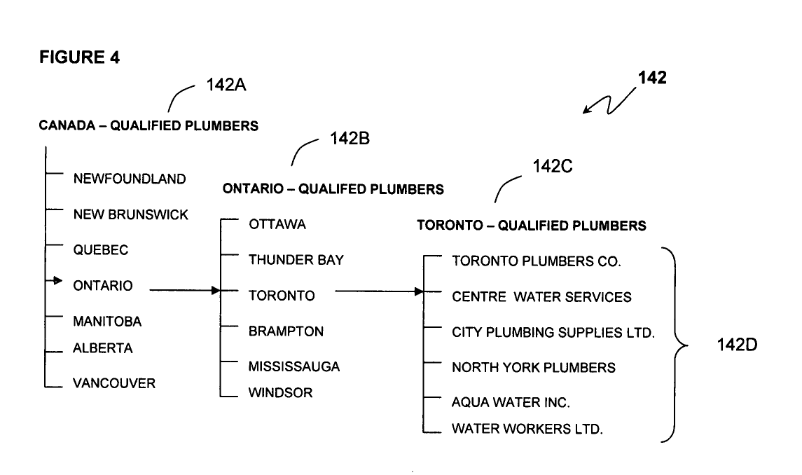

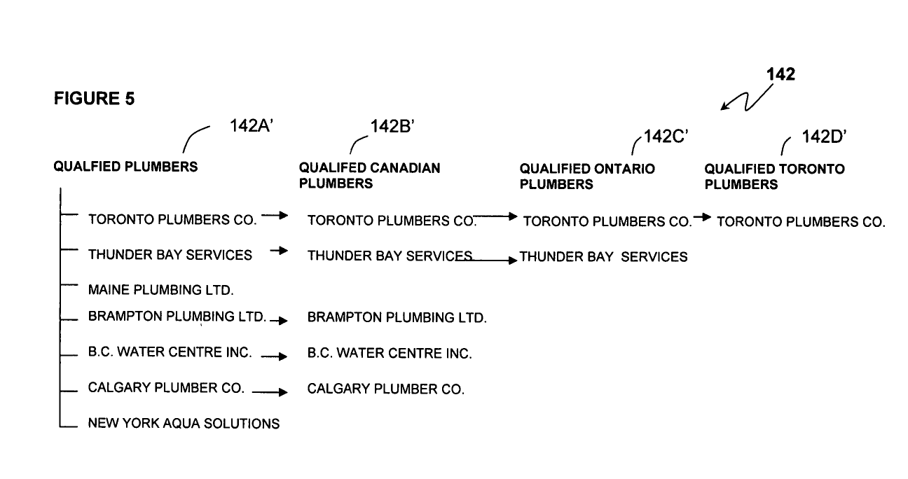

At step 142, the ordering system searches within the database for suitable qualified service providers capable of fulfilling the order within the same geographic region as the user. As shown in FIGS. 4 and 5, the qualified service providers may be organized and stored in the database according to one or more hierarchies. For instance, in FIG. 4, the qualified services providers are organized and stored in the database primarily according to their geographic location. The types of goods and/or services that the service provider provides would form a secondary hierarchy. For example, a user situated in Toronto, Ontario, Canada submits an order for a plumber to repair a leaking facet. Based on the user's contact data, the ordering system identifies all of the service providers within the database that are situated in “Canada” [step 142A], then within “Ontario” [step 142B] and finally within “Toronto” [step 142C]. With the scope of service providers limited to “Toronto”, the ordering system may then search for a Toronto-based “plumber” to fulfill the order [step 142D].

Conversely, as shown in FIG. 5, the service providers may be primarily organized in hierarchies based on the goods and/or services they provide. The location of the service providers would form a secondary hierarchy. For example, in respect to the user situated in Toronto, Ontario, Canada with a leaking facet, the ordering system at step would first identify all of the “plumbers” stored in the database [Step 142A′]. The ordering system would then determine whether any of the stored “plumbers” are located in Canada [step 142B′]. Next, “plumbers” situated in Ontario and Toronto would be identified at steps 142C′ and 142D′, respectively.

Although two different hierarchical methods of identifying and storing the service providers have been shown in FIGS. 4 and 5, it will be apparent to those skilled in the art that many configurations and organizations of the service providers in the system database are possible without departing from the scope of the present invention. For example, it will be obvious to those skilled in the art that the service providers may be stored in the system database and identified using a search engine. It will also be obvious to those skilled in the art that the data stored in the system database may be distributed across multiple storage means.

If, at step 142, a qualified service provider is not located within the same geographic area as the user, the method will proceed back to step 140 and attempt to locate a service provider in an adjoining geographic area. The method will perform successive iterations of steps 140 and 142 until one or more qualified service providers capable of fulfilling the order are located.

At step 144, a list of qualified service providers is generated. The list of qualified service providers may be ranked to determine which service provider should be selected to fulfill the user's order. The service providers may be ranked according to the quality or cost of the qualified service provider's goods or services. For example, the ordering system may be adapted to communicate with the Better Business Bureau to determine which qualified service providers have the most favourable reviews from customers. To ensure the reliability of the ordering system to users, it is important to maintain a list of qualified service providers that are capable of fulfilling the order in a professional and responsible manner.

Referring to FIG. 3B, based on the output of the ranking at step 144, a first qualified service provider may be located at step 146. The user's order and contact data are communicated to the first qualified service provider at step 148. Preferably, the order is sent to the qualified service provider as an electronic message or text file. However, it will be understood that any suitable method of communicating the order may be utilized by the ordering system, such as, for example, voice mail and faxed transmissions. At step 150, the first qualified service provider must decide whether to accept or decline the order from the ordering system. If the order is accepted, at step 152 the first selected qualified service provider may immediately fulfill the order or make arrangements with the user to provide the goods and/or services at the convenience of both parties. The method then end at step 152.

If the first selected qualified service provider declines the order, the method returns to step 146 and a second selected qualified service provider is determined from the list of qualified service providers. The method will perform successive iterations of steps 146 through 150 until an available qualified service provider capable of fulfilling the order accepts the order and provides and/or performs the requested goods and/or services.

In use, the ordering system is designed to facilitate the ordering of goods and/or services by a user in a timely and efficient manner. By this design, the ordering system is an automated butler which receives orders from the user and identifies and selects available qualified service providers to fulfill or perform the orders for the benefit of the user. In an embodiment of the present invention, the user merely submits one or more orders by telephone to a centralized ordering system (e.g. using a 1-800 telephone number). The ordering system may also be accessed by the user while on vacation in a foreign country because the system is multi-lingual and may receive orders in a wide variety of languages. Although dependent on the nature of the good or service requested, the submission of orders would ideally require less than one minute of the user's time. Upon receipt of the one or more orders, the ordering system will analyze the user's orders and identify and select available qualified service providers in the same geographic location as the user to fulfill the orders. While the ordering system is identifying and selecting qualified service providers to provide the goods or perform the services, the user may attend to other tasks, such as spending quality time with their spouse, children and friends. The use of the ordering system of the present invention will enable to a user to access the time and life management benefits of a butler or a personal assistant without being burdened by the considerable costs associated with hiring a butler on a full-time basis.

In variant embodiments of the present invention, it will be obvious to those skilled in the art that there are numerous possible configurations of the system interface and other components of the ordering system, in a web-based or other implementation of the present invention. Components of application servers and web servers can be combined on a single server or distributed across several servers as desired. Firewalls and other similar security techniques may be implemented in the ordering system to prevent unauthorized access to private information. Additional components to facilitate the collection of fees or commissions from users and/or service providers for each order may also be implemented.

The present invention has been described with regard to specific embodiments. However, it will obvious to persons skilled in the art that a number of variants and modifications can be made without departing from the scope and spirit of the invention.

1. A system for facilitating the ordering of goods and services by a user, comprising:
a) a system database for storing data received from a user and one or more service providers, wherein said data is associated with one or more orders for goods and services submitted by said user, and wherein said data is associated with goods and services provided by said one or more qualified service providers;
b) one or more interfaces for receiving said one or more orders from said user and communicating said one or more orders to said one or more qualified service providers;
c) at least one module connected to said database and said one or more interfaces, said at least one module programmed to analyze said one or more orders to identify and rank at least one qualified service provider for fulfilling said one or more orders for said user.

2. The system as claimed in claim 1 further comprising a communication module for receiving said one or more orders from said user and communicating said orders to said at least one available qualified service provider.

3. The system as claimed in claim 2, wherein said communication module is programmed to receive said orders in voice, text and image formats.

4. The system as claimed in claim 3, wherein said communication module is programmed to receive said orders in a plurality of languages.

5. The system as claimed in claim 1 further comprising a ranking module programmed to generate a list of one or more qualified service providers for fulfilling said one or more orders for said user.

6. The system as claimed in claim 5, wherein said ranking module is adapted to rank said qualified service providers in said list to identify said at least one available qualified service provider.

7. A method for facilitating the ordering of goods and services by a user, said method comprising the steps of:
a) receiving one or more orders for goods and services from said user, wherein said one or more orders identify the goods and services requested;
b) analyzing and transcribing said one or more orders to determine the goods and services requested by said user;
c) generating a list of one or more qualified service providers to provide the goods and services requested to said user;
d) ranking and selecting at least one available qualified service provider from said list of one or more qualified service providers; and
e) communicating with said at least one available qualified service provider to fulfill said one or more orders for goods and services for said user.

8. The method as claimed in claim 7, wherein said one or more orders further include contact data identifying said user.

9. The method as claimed in claim 8, wherein said contact data associated with each user is a pre-set identifier.

10. The method as claimed in claim 9, wherein said contact data associated with each user is a telephone number.

11. The method as claimed in claim 9, wherein said contact data associated with each user is a user name and password.

12. The method as claimed in claim 7, wherein said one or more orders are received in voice, text and image formats.

13. The method as claimed in claim 7, wherein said one or more orders are submitted in one or more of a plurality of languages.
